(19) United States
(12) Patent Application Publication
(10) Pub. No.: US 2024/0357446 A1
(43) Pub. Date: Oct. 24, 2024

(54) CELL HANDOVER METHOD, CELL HANDOVER APPARATUS, AND STORAGE MEDIUM

(71) Applicant: BEIJING XIAOMI MOBILE SOFTWARE CO., LTD., Beijing (CN)

(72) Inventor: Xuhua TAO, Beijing (CN)

(73) Assignee: BEIJING XIAOMI MOBILE SOFTWARE CO., LTD., Beijing (CN)

(21) Appl. No.: 18/575,729

(22) PCT Filed: Jun. 29, 2021
(86) PCT No.: PCT/CN2021/103237

§ 371 Date: Dec. 29, 2023

(51) Int. Cl. H04W 36/00; H04W 36/36

(52) U.S. Cl. CPC H04W 36/0085; H04W 36/0055; H04W 36/362

(57) ABSTRACT

A cell handover method is performed by a terminal and includes: identifying indication signaling in response to performing a cell handover procedure according to a conditional handover (CHO) command, where the indication signaling is configured to indicate at least one candidate target cell and a pre-defined rule for the terminal performing a cell handover; and determining, based on the rule, a target cell of the handover from the at least one candidate target cell.

### CROSS-REFERENCE TO RELATED APPLICATION

This application is the U.S. national phase application of International Application No. PCT/CN2021/103237, filed on Jun. 29, 2021, the disclosure of which is incorporated herein by reference in its entirety for all purposes.

### BACKGROUND

In new generation communication technologies, a conditional handover (CHO) command is introduced to reduce the number of connection failures of a terminal during it is moving. In particular, a network configures one or a plurality of candidate target cells for the terminal. When one or more target cells meet a configured condition, the terminal executes the CHO command, so as to autonomously select one target cell that meets the condition from the one or the plurality of configured candidate target cells for a handover.

However, some problems occur due to load balancing, such as that the target cell autonomously selected by the terminal may not be the best cell for the handover, or that a cell handover failure is caused.

### SUMMARY

The present disclosure relates to the field of wireless communication technologies, and in particular to a cell handover method, a cell handover apparatus and a storage medium.

According to a first aspect of the present disclosure, a cell handover method is provided, performed by a terminal and including:
identifying indication signaling, wherein the indication signaling is configured to indicate at least one candidate target cell and a rule for the terminal performing a cell handover; and determining, based on the rule, a target cell of the handover from the at least one candidate target cell.

According to a second aspect of the present disclosure, a cell handover method is provided, performed by a network device and including:
determining at least one candidate target cell and a rule, wherein the rule is used for a terminal to determine a target cell of a handover from the at least one candidate target cell; and transmitting indication signaling, wherein the indication signaling is configured to indicate the at least one candidate target cell and the rule for the terminal performing a cell handover.

According to a third aspect of the present disclosure, a terminal is provided, including:
one or more processors; and one or more memories for storing instructions executable by the one or more processors; wherein the one or more processors are configured to identify indication signaling, wherein the indication signaling is configured to indicate at least one candidate target cell and a rule for the terminal performing a cell handover; and determine, based on the rule, a target cell of the handover from the at least one candidate target cell.

The above general description and the following detailed description are only illustrative and explanatory, and are not intended to limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 illustrates an architecture diagram of a communication system of a network device and terminals according to an example of the present disclosure.

FIG. 2 illustrates a flowchart of a cell handover method according to an example of the present disclosure.

FIG. 3 illustrates a flowchart of a cell handover method according to an example of the present disclosure.

FIG. 4 illustrates a flowchart of a cell handover method according to an example of the present disclosure.

FIG. 5 illustrates a flowchart of a cell handover method according to an example of the present disclosure.

FIG. 6 illustrates a block diagram of a cell handover apparatus according to an example of the present disclosure.

FIG. 7 illustrates a block diagram of a cell handover apparatus according to an example of the present disclosure.

FIG. 8 illustrates a block diagram of an apparatus for a cell handover according to an example of the present disclosure.

FIG. 9 illustrates a block diagram of an apparatus for a cell handover according to an example of the present disclosure.

### DETAILED DESCRIPTION OF THE EMBODIMENTS

Embodiments will be described in detail here with the examples thereof illustrated in the drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The word “if” as used here may be interpreted as “when,” “upon,” or “in response to determining.”

In new 3^{rd} Generation Partnership Project (3GPP), conditional handover (CHO) is introduced in the stage Rel-16 to reduce the number of connection failures of a terminal during it is moving. For example, cell handover failures, or connection failures before a cell handover is triggered. In a general handover process, a network configures only one target cell for the cell handover. For the CHO, however, the network may configure at least one candidate target cell in advance. Under a good connection condition, the network may transmit a CHO command as a cell handover command to the terminal in advance. After receiving the CHO command, the terminal may store the CHO command. When the at least one configured candidate target cell meets a configured condition, the terminal executes the stored CHO command, performs the handover to a target cell, and connects to the target cell.

During the process that the terminal performs the handover to the target cell, the terminal selects the target cell of the handover from the at least one candidate target cell according to the CHO command. In this case, the terminal may autonomously select one of the cells that meet the condition and performs the handover. However, there are some problems due to load balancing in the case where the terminal autonomously selects the target cell, such as that the target cell of the handover is not the best target cell, or that the handover failure may occur. Therefore, it is expected to optimize the way of selecting the target cell in the CHO handover process. In view of this, the present disclosure provides a cell handover method. When a cell handover is performed as the configured CHO command is met, the terminal may determine the target cell of the handover from the at least one candidate target cell configured by the network based on a priority order of the candidate target cells and/or signal reference signal qualities of the candidate target cells.

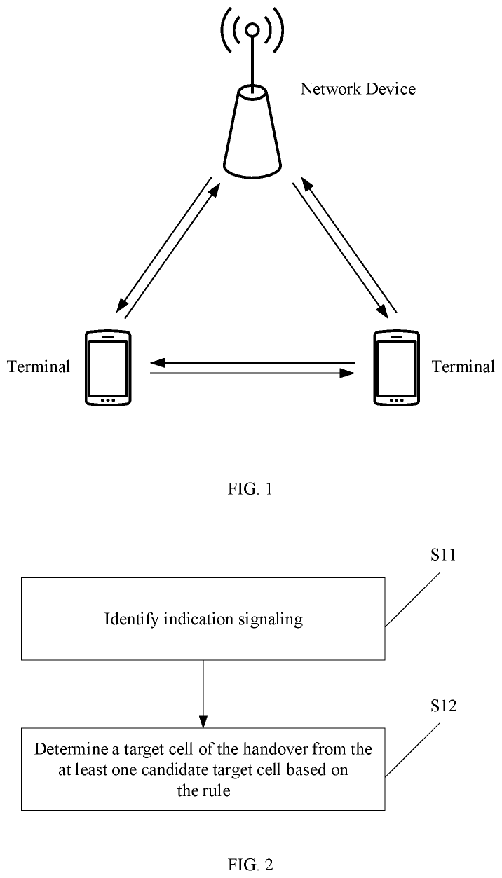

FIG. 1 illustrates an architecture diagram of a communication system of a network device and terminals according to an example. The cell handover method provided by the present disclosure may be applicable to the architecture diagram of the communication system illustrated in FIG. 1. As illustrated in FIG. 1, a network device may transmit signaling on the basis of the architecture illustrated in FIG. 1.

The communication system of the network device and the terminals, as illustrated in FIG. 1, is only a schematic illustration. The wireless communication system may further include other network devices, such as core network devices, wireless relay devices, and wireless backhaul devices, etc., which are not illustrated in FIG. 1. The example of the present disclosure has no limit for the number of the network devices and the number of the terminals included in the wireless communication system.

In some examples, the wireless communication system in the example of the present disclosure is a network that provides wireless communication functions. The wireless communication system may be based on different communication technologies, such as code division multiple access (CDMA), wideband code division multiple access (WCDMA), time division multiple access (TDMA), frequency division multiple access (FDMA), orthogonal frequency division multiple access (OFDMA), single carrier frequency division multiple access (SC-FDMA), and carrier sense multiple access with collision avoidance. According to the factors such as capacity, speed and delay in different networks, a network may be classed into a 2nd generation (2G) network, a 3G network, a 4G network or a future evolution network, such as a 5G network that is also called a new radio (NR) network. For convenience of description, the present disclosure sometimes refers to the wireless communication network as a network for short.

Further, the network device involved in the present disclosure may also be referred to as a radio access network device. The wireless access network device may be a base station, an evolved node B, a femtocell, an access point (AP) in a wireless fidelity (WiFi) system, a wireless relay node, a wireless backhaul node, a transmission point (TP) or a transmission and reception point (TRP), etc., or may be a gNB in an NR system. Alternatively, the wireless access device may be a device that constitutes a component or a part of a base station. In a vehicle-to-everything (V2X) communication system, the network device may be an in-vehicle device. The example of the present disclosure has no limit for the specific technology and the specific device form of the network device.

Further, the terminal involved in the present disclosure, as a device that provides voice and/or data connectivity for a user, may also be referred to as terminal equipment, user equipment (UE), a mobile station (MS), a mobile terminal (MT), etc. For example, the terminal may be a handheld device, an in-vehicle device, or the like which is equipped with a wireless connection function. At present, some examples of the terminal include a mobile phone, a pocket personal computer (PPC), a handheld computer, a personal digital assistant (PDA), a notebook computer, a tablet computer, a wearable device, an in-vehicle device, or the like. In the V2X communication system, the terminal device may be an in-vehicle device. The example of the present disclosure has no limit for the specific technology and the specific device form of the terminal.

FIG. 2 illustrates a flowchart of a cell handover method according to an example. As illustrated in FIG. 2, the cell handover method is performed by a terminal and includes the following steps.

At step S11, indication signaling is identified.

Alternatively or additionally, an example of the present disclosure identifies the indication signaling in response to that a cell handover procedure is performed according to a CHO command.

The indication signaling is configured to indicate at least one candidate target cell and a rule for the terminal performing a cell handover.

In an example of the present disclosure, in the case where the terminal is configured with the CHO command, the terminal performs the cell handover procedure according to the CHO command configured by the network device. In response to performing the cell handover procedure according to the CHO command, the terminal determines the at least one candidate target cell configured by the network device, and determines the rule for performing the cell handover on the basis of the at least one candidate target cell.

The rule may be predefined, may be specified according to provisions of a protocol, or of course, may be agreed with each other, which is not limited concretely here.

At step S12, a target cell of the handover is determined from the at least one candidate target cell based on the rule.

In an example of the present disclosure, the terminal performs the target cell handover procedure according to the CHO command, determines the rule configured by the network device, and determines the target cell of the handover from the at least one candidate target cell based on the rule.

Through the cell handover method provided by the examples of the present disclosure, for the target cell of the handover among the candidate target cell(s), it may be determined by the terminal based on the rule configured by the network device, rather than be determined autonomously by the terminal. Therefore, it achieves an effect that the target cell of the handover is the best and then a CHO handover performance can be improved.

In some examples of the present disclosure, the indication signaling includes conditional reconfiguration signaling (IE Conditional Reconfiguration) and conditional re-adding module list signaling (IF Cond Reconfig To Add Mod List).

The conditional reconfiguration signaling is configured to indicate the at least one candidate target cell.

The conditional re-adding module list signaling is configured to indicate the rule for the terminal performing the cell handover.

In some examples of the present disclosure, the rule may include a cell's handover priority and/or a cell's signal quality strength. The signal quality of the cell may be determined based on a measurement result of a reference signal. The reference signal may be associated with a synchronization signal, such as a synchronization signal reference signal received power (SS-RSRP) or a synchronization signal reference signal receiving quality (SS-RSRQ) or a synchronization signal to interference noise ratio (SS-SINR). The reference signal may also be associated with channel state information (CSI), such as a CSI-RSRP or a CSI-RSRQ or a CSI-SINR.

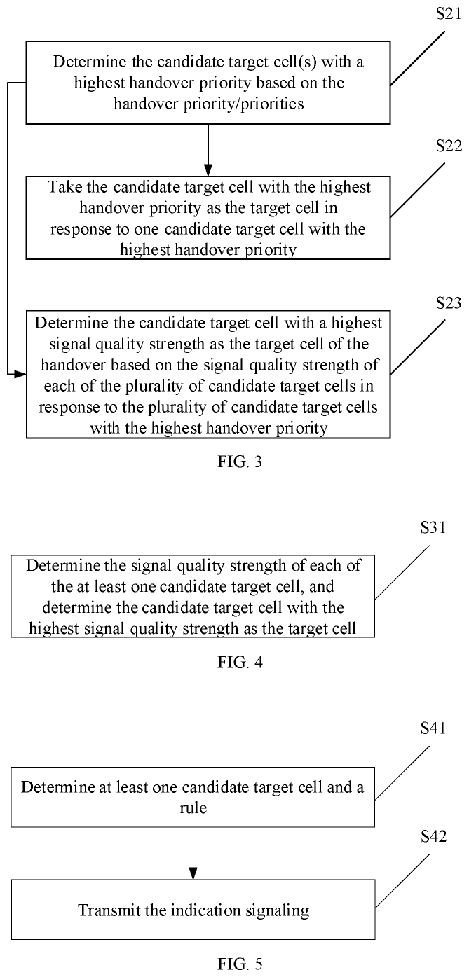

FIG. 3 illustrates a flowchart of a cell handover method according to an example. As illustrated in FIG. 3, the cell handover method is performed by the terminal and includes the following steps.

At step S21, the candidate target cell(s) with a highest handover priority is determined based on the handover priority/priorities.

In an example of the present disclosure, if the rule includes both the cell's handover priority and the cell's signal quality strength, the terminal selects the candidate target cell(s) with the highest handover priority based on the handover priority/priorities. There may be one or a plurality of candidate target cells that are selected based on the handover priority/priorities.

At step S22, the candidate target cell with the highest handover priority is taken as the target cell in response to one candidate target cell with the highest handover priority.

In some examples of the present disclosure, if there is one candidate target cell selected based on the handover priority/priorities, the terminal may directly determine the candidate target cell as the target cell, and perform the handover to access to the determined target cell.

At step S23, the candidate target cell with a highest signal quality strength is determined as the target cell of the handover based on the signal quality strength of each of the plurality of candidate target cells in response to the plurality of candidate target cells with the highest handover priority.

In some examples of the present disclosure, if there are the plurality of candidate target cells selected based on the handover priority/priorities, it may further determine a measurement result of the signal quality strength of each of the plurality of candidate target cells, and sort the measurement results. By sorting the signal quality strength of each of the plurality of candidate target cells, the candidate target cell with the highest signal quality strength is determined from the plurality of candidate target cells with the highest priority and is taken as the target cell of the handover.

FIG. 4 illustrates a flowchart of a cell handover method according to an example. As illustrated in FIG. 4, the cell handover method is performed by the terminal and includes the following step.

At step S31, the signal quality strength of each of the at least one candidate target cell is determined, and the candidate target cell with the highest signal quality strength is determined as the target cell.

In some examples of the present disclosure, if the rule configured by the network device for the terminal includes the cell's signal quality strength, the terminal obtains the measurement result of the signal quality strength of each of the at least one candidate target cell, sorts the measurement result(s), determines the highest signal quality strength in the measurement result(s), and determines the corresponding cell as the target cell.

Based on the same/similar concept, the examples of the present disclosure also provide a cell handover method.

FIG. 5 illustrates a flowchart of a cell handover method according to an example. As illustrated in FIG. 5, the cell handover method is performed by a network device and includes the following steps.

At step S41, at least one candidate target cell and a rule are determined.

Alternatively or additionally, an example of the present disclosure determines an indication signaling in response to that a cell handover procedure is performed according to a CHO command. In the example of the present disclosure, the network device determines that the CHO command is configured for the terminal, and then further determines the at least one candidate target cell and the rule configured for the terminal.

The rule may be predefined, may be specified based on provisions of a protocol, or of course, may be agreed with each other, which is not limited concretely here.

The rule is used for the terminal to determine a target cell of the handover from the at least one candidate target cell.

At step S42, the indication signaling is transmitted.

The indication signaling is configured to indicate the at least one candidate target cell and the rule for the terminal performing a cell handover.

In the example of the present disclosure, the network device transmits the indication signaling, so as to indicate the terminal to determine the target cell of the handover based on the at least one candidate target cell and the rule for the terminal performing the cell handover which are included in the indication signaling.

Through the cell handover method provided by the examples of the present disclosure, for the target cell of the handover among the candidate target cell(s), it may be determined by the terminal based on the rule configured by the network device, rather than be determined autonomously by the terminal. Therefore, it achieves an effect that the target cell of the handover is the best and then a CHO handover performance can be improved.

In some examples of the present disclosure, the indication signaling includes conditional reconfiguration signaling and conditional re-adding module list signaling.

The conditional reconfiguration signaling is configured to indicate the at least one candidate target cell.

The conditional re-adding module list signaling is configured to indicate the rule for the terminal performing the cell handover.

In some examples of the present disclosure, the rule may include a cell's handover priority and/or a cell's signal quality strength. The signal quality of the cell may be determined based on a measurement result of a reference signal. The reference signal may be associated with a synchronization signal, such as an SS-RSRP or an SS-RSRQ or an SS-SINR. The reference signal may also be associated with CSI, such as a CSI-RSRP or a CSI-RSRQ or a CSI-SINR.

Based on the same concept, the examples of the present disclosure also provide a cell handover apparatus.

The cell handover apparatus provided in the examples of the present disclosure includes hardware structures and/or software modules corresponding to the execution of each function in order to achieve the above functions. Through combining with the units and the algorithm steps of each example disclosed in the examples of the present disclosure, the examples of the present disclosure may be implemented in a form of hardware or a combination of hardware and computer software. Whether a certain function is performed in hardware or in a way that the computer software drives the hardware depends on various specific applications and design constraints of the technical solution. Those skilled in the art may use different approaches to implement the described function for each specific application, which are not to be considered beyond the scope of the technical solutions provided by the examples of the present disclosure.

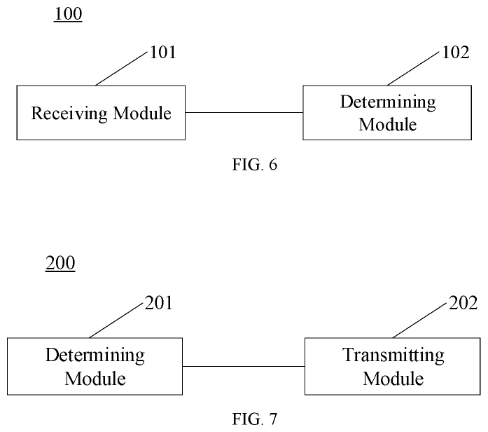

FIG. 6 illustrates a block diagram of a cell handover apparatus according to an example. In referring to FIG. 6, the cell handover apparatus 100 is applicable to a terminal, and includes a receiving module 101 and a determining module 102.

The receiving module 101 is configured to identify indication signaling. The indication signaling is configured to indicate at least one candidate target cell and a rule for the terminal performing a cell handover. The determining module 102 is configured to determine, based on the rule, a target cell of the handover from the at least one candidate target cell.

Alternatively or additionally, the receiving module 101 in an example of the present disclosure identifies the indication signaling in response to performing a cell handover procedure according to a CHO command.

In an example of the present disclosure, the indication signaling includes conditional reconfiguration signaling and conditional re-adding module list signaling.

The conditional reconfiguration signaling is configured to indicate the at least one candidate target cell. The conditional re-adding module list signaling is configured to indicate the rule for the terminal performing the cell handover.

In an example of the present disclosure, the rule includes:
a cell's handover priority and/or a cell's signal quality strength.

In an example of the present disclosure, the determining module 102 is configured to determine, based on the handover priority/priorities, candidate target cell(s) with a highest handover priority. In response to one candidate target cell with the highest handover priority, the determining module 102 takes the candidate target cell with the highest handover priority as the target cell. In response to a plurality of candidate target cells with the highest handover priority, the determining module 102 determines, based on the signal quality strength of each of the plurality of candidate target cells, the candidate target cell with a highest signal quality strength as the target cell of the handover.

In an example of the present disclosure, the rule includes the cell's signal quality strength.

The determining module 102 is configured to determine the signal quality strength of each of the at least one candidate target cell, and determine the candidate target cell with the highest signal quality strength as the target cell.

FIG. 7 illustrates a block diagram of a cell handover apparatus according to an example. In referring to FIG. 7, the cell handover apparatus 200 is applicable to a network device and includes a determining module 201 and a transmitting module 202.

The determining module 201 is configured to determine at least one candidate target cell and a rule. The rule is used for a terminal to determine a target cell of a handover from the at least one candidate target cell.

Alternatively or additionally, the determining module 201 in an example of the present disclosure determines the indication signaling in response to that a cell handover procedure is performed according to a CHO command.

The transmitting module 202 is configured to transmit the indication signaling. The indication signaling is configured to indicate the at least one candidate target cell and the rule for the terminal performing the cell handover.

In an example of the present disclosure, the rule includes:
a cell's handover priority and/or a cell's signal quality strength.

In an example of the present disclosure, the indication signaling includes conditional reconfiguration signaling and conditional re-adding module list signaling.

The conditional reconfiguration signaling is configured to indicate the at least one candidate target cell. The conditional re-adding module list signaling is configured to indicate the rule for the terminal performing the cell handover.

With respect to the apparatus in the foregoing examples, the specific manner in which each module performs its operation has been described in detail in the examples of the related methods, and will not be further elaborated here.

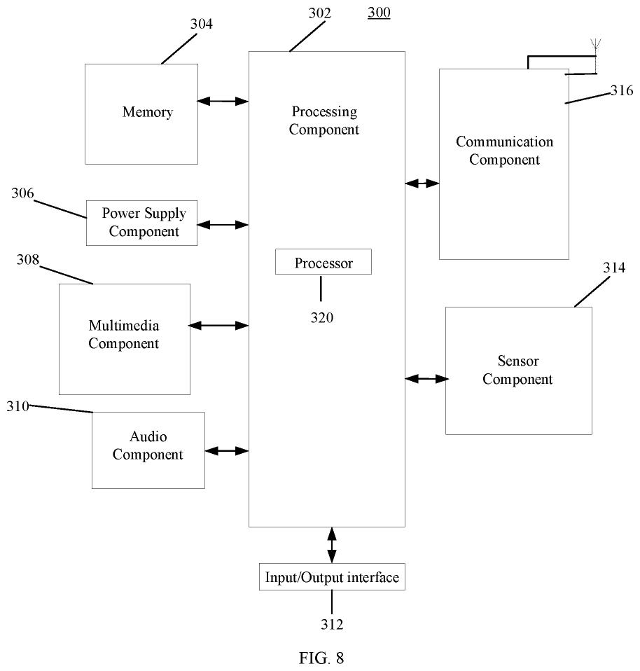

FIG. 8 illustrates a block diagram of an apparatus for a cell handover according to an example. For example, the apparatus 300 may be a mobile phone, a computer, a digital broadcasting terminal, a messaging device, a game console, a tablet device, a medical device, a fitness device, a personal digital assistant, and the like.

In referring to FIG. 8, the apparatus 300 may include one or more of the following components: a processing component 302, a memory 304, a power supply component 306, a multimedia component 308, an audio component 310, an input/output (I/O) interface 312, a sensor component 314, and a communication component 316.

The processing component 302 generally controls the overall operations of the apparatus 300, such as operations associated with display, phone calls, data communications, camera operations, and recording operations. The processing component 302 may include one or more processors 320 to execute instructions to complete all or a part of the steps of the above methods. In addition, the processing component 302 may include one or more modules which facilitate the interaction between the processing component 302 and other components. For example, the processing component 302 may include a multimedia module to facilitate the interaction between the multimedia component 308 and the processing component 302.

The memory 304 is configured to store various types of data to support the operations of the apparatus 300. Examples of such data include instructions for any application or method operated on the apparatus 300, contact data, phonebook data, messages, pictures, videos, and the like. The memory 304 may be implemented by any type of volatile or non-volatile storage device or a combination thereof, such as a static random access memory (SRAM), an electrically erasable programmable read-only memory (EEPROM), an erasable and programmable read-only memory (EPROM), a programmable read-only memory (PROM), a read-only memory (ROM), a magnetic memory, a flash memory, a magnetic disk or an optical disk.

The power supply component 306 provides power for various components of the apparatus 300. The power supply component 306 may include a power management system, one or more power supplies, and other components associated with generating, managing, and distributing power for the apparatus 300.

The multimedia component 308 includes a screen providing an output interface between the apparatus 300 and a user. In some examples, the screen may include a liquid crystal display (LCD) and a touch panel (TP). If the screen includes the TP, the screen may be implemented as a touch screen to receive input signals from the user. The TP may include one or more touch sensors to sense touches, swipes, and gestures on the TP. The touch sensors may not only sense a boundary of a touch or swipe, but also sense a lasting time and a pressure associated with the touch or swipe. In some examples, the multimedia component 308 includes a front camera and/or a rear camera. The front camera and/or rear camera may receive external multimedia data when the apparatus 300 is in an operating mode, such as a photographing mode or a video mode. Each front camera and rear camera may be a fixed optical lens system or have focal length and optical zooming capability.

The audio component 310 is configured to output and/or input an audio signal. For example, the audio component 310 includes a microphone (MIC) that is configured to receive an external audio signal when the apparatus 300 is in an operating mode, such as a call mode, a recording mode, and a voice recognition mode. The received audio signal may be further stored in memory 304 or transmitted via communication component 316. In some examples, the audio component 310 also includes a speaker for outputting an audio signal.

The I/O interface 312 provides an interface between the processing component 302 and a peripheral interface module. The above peripheral interface module may be a keyboard, a click wheel, buttons, or the like. These buttons may include but not limited to a home button, a volume button, a start button and a lock button.

The sensor component 314 includes one or more sensors to provide the apparatus 300 with status assessments in various aspects. For example, the sensor component 314 may detect an open/closed state of the apparatus 300 and a relative positioning of components such as the display and keypad of the apparatus 300, and the sensor component 314 can also detect a change in position of the apparatus 300 or a component of the apparatus 300, the presence or absence of user contact with the apparatus 300, orientation or acceleration/deceleration of the apparatus 300, and temperature change of the apparatus 300. The sensor component 314 may include a proximity sensor configured to detect the presence of a nearby object without any physical contact. The sensor component 314 may further include an optical sensor, such as a Complementary Metal-Oxide-Semiconductor (CMOS) or Charged Coupled Device (CCD) image sensor, for being applied in imaging applications. In some examples, the sensor component 314 may also include an acceleration sensor, a gyro sensor, a magnetic sensor, a pressure sensor, or a temperature sensor.

The communication component 316 is configured to facilitate wired or wireless communication between the apparatus 300 and other devices. The apparatus 300 may access a wireless network based on a communication standard, such as Wi-Fi, 2G, 3G, 4G, 5G or a combination thereof. In an example, the communication component 316 receives broadcast signals or broadcast related information from an external broadcast management system via a broadcast channel. In an example, the communication component 316 also includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth® (BT) technology and other technologies.

In one or more examples, the apparatus 300 may be implemented by at least one application specific integrated circuit (ASIC), digital signal processor (DSP), digital signal processing device (DSPD), programmable logic device (PLD), field programmable gate array (FPGA), controller, microcontroller, microprocessor, or another electronic component for performing the above methods.

In one or more examples, there is also provided a non-transitory computer-readable storage medium including instructions, such as the memory 304 including instructions. These instructions may be executed by the one or more processors 320 of the apparatus 300 to complete the above methods. For example, the non-transitory computer-readable storage medium may be a read-only memory (ROM), a random access memory (RAM), a CD-ROM, a magnetic tape, a floppy disk, an optical data storage device, and the like.

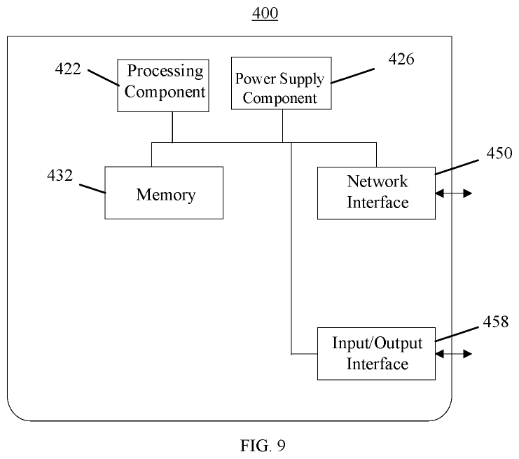

FIG. 9 illustrates a block diagram of an apparatus for a cell handover according to an example. For example, the apparatus 400 may be provided as a server. In referring to FIG. 9, the apparatus 400 includes a processing component 422 which further includes one or more processors, and a memory resource represented by a memory 432 which is used to store instructions that may be executed by the processing component 422, such as application programs. The application programs stored in the memory 432 may include one or more modules, each of which corresponds to a set of instructions. In addition, the processing component 422 is configured to execute the instructions to perform the above methods.

The apparatus 400 may also include a power supply component 426 configured to perform power management of the apparatus 400, a wired or wireless network interface 450 configured to connect the apparatus 400 to a network, and an input/output (I/O) interface 458. The apparatus 400 may operate an operating system stored in the memory 432, which is based on Windows Server™, Mac OS X™, Unix™, Linux™, FreeBSD™ or the like.

The technical solutions provided by the examples of the present disclosure may include the following beneficial effects: in a case where a conditional handover (CHO) command is configured for a terminal, by configuring a handover rule of a target cell for the terminal, the terminal determines a target cell of a handover based on the rule, so as to achieve an effect that the target cell of the handover is the best and then a CHO handover performance can be improved.

According to a first aspect of the examples of the present disclosure, a cell handover method is provided, performed by a terminal and including: identifying indication signaling, wherein the indication signaling is configured to indicate at least one candidate target cell and a rule for the terminal performing a cell handover; and determining, based on the rule, a target cell of the handover from the at least one candidate target cell.

In an implementation, the indication signaling includes conditional reconfiguration signaling and conditional re-adding module list signaling. The conditional reconfiguration signaling is configured to indicate the at least one candidate target cell, and the conditional re-adding module list signaling is configured to indicate the rule for the terminal performing the cell handover.

In an implementation, the rule includes: a cell's handover priority and/or a cell's signal quality strength.

In an implementation, determining, based on the rule, the target cell of the handover from the at least one candidate target cell includes: determining, based on a handover priority, candidate target cell(s) with a highest handover priority; taking, in response to one candidate target cell with the highest handover priority, the candidate target cell with the highest handover priority as the target cell; and determining, in response to a plurality of candidate target cells with the highest handover priority, the candidate target cell with a highest signal quality strength as the target cell of the handover based on the signal quality strength of each of the plurality of candidate target cells.

In an implement, the rule includes a cell's signal quality strength. Determining, based on the rule, the target cell of the handover from the at least one candidate target cell includes: determining the signal quality strength of each of the at least one candidate target cell, and determining the candidate target cell with a highest signal quality strength as the target cell.

According to a second aspect of the examples of the present disclosure, a cell handover method is provided, performed by a network device and including: determining at least one candidate target cell and a rule, wherein the rule is used for a terminal to determine a target cell of a handover from the at least one candidate target cell; and transmitting indication signaling, wherein the indication signaling is configured to indicate the at least one candidate target cell and the rule for the terminal performing a cell handover.

In an implementation, the rule includes: a cell's handover priority and/or a cell's signal quality strength.

In an implementation, the indication signaling includes conditional reconfiguration signaling and conditional re-adding module list signaling. The conditional reconfiguration signaling is configured to indicate the at least one candidate target cell, and the conditional re-adding module list signaling is configured to indicate the rule for the terminal performing the cell handover.

According to a third aspect of the examples of the present disclosure, a cell handover apparatus is provided, being applicable to a terminal and including: a receiving module, configured to identify indication signaling, wherein the indication signaling is configured to indicate at least one candidate target cell and a rule for the terminal performing a cell handover; and a determining module, configured to determine, based on the rule, a target cell of the handover from the at least one candidate target cell.

In an implementation, the indication signaling includes conditional reconfiguration signaling and conditional re-adding module list signaling. The conditional reconfiguration signaling is configured to indicate the at least one candidate target cell, and the conditional re-adding module list signaling is configured to indicate the rule for the terminal performing the cell handover.

In an implementation, the rule includes: a cell's handover priority and/or a cell's signal quality strength.

In an implementation, the determining module is configured to: determine, based on a handover priority, candidate target cell(s) with a highest handover priority; take, in response to one candidate target cell with the highest handover priority, the candidate target cell with the highest handover priority as the target cell; and determine, in response to a plurality of candidate target cells with the highest handover priority, the candidate target cell with a highest signal quality strength as the target cell of the handover based on the signal quality strength of each of the plurality of candidate target cells.

In an implement, the rule includes a cell's signal quality strength. The determining module is configured to: determine the signal quality strength of each of the at least one candidate target cell, and determine the candidate target cell with a highest signal quality strength as the target cell.

According to a fourth aspect of the examples of the present disclosure, a cell handover apparatus is provided, being applicable to a network device and including: a determining module, configured to determine at least one candidate target cell and a rule, wherein the rule is used for a terminal to determine a target cell of a handover from the at least one candidate target cell; and a transmitting module, configured to transmit indication signaling, wherein the indication signaling is configured to indicate the at least one candidate target cell and the rule for the terminal performing a cell handover.

In an implementation, the rule includes: a cell's handover priority and/or a cell's signal quality strength.

In an implementation, the indication signaling includes conditional reconfiguration signaling and conditional re-adding module list signaling. The conditional reconfiguration signaling is configured to indicate the at least one candidate target cell, and the conditional re-adding module list signaling is configured to indicate the rule for the terminal performing the cell handover.

According to a fifth aspect of the examples of the present disclosure, a cell handover apparatus is provided, including: one or more processors; and one or more memories for storing instructions executable by the one or more processors; wherein the one or more processors are configured to perform the cell handover method according to the first aspect or any one implementation thereof, or perform the cell handover method according to the second aspect or any one implementation thereof.

According to a sixth aspect of the examples of the present disclosure, a non-transitory computer-readable storage medium is provided. Instructions in the storage medium, when executed by one or more processors of a mobile terminal, enable the mobile terminal to perform the cell handover method according to the first aspect or any one implementation thereof, or enable the mobile terminal to perform the cell handover method according to the second aspect or any one implementation thereof.

The term “plurality” in the present disclosure refers to two or more than two, and other quantifiers are similar. The term “and/or” describes the association relationships between associated objects, indicating that there can be three types of relationships. For example, A and/or B means that A exists alone, A and B exist at the same time, and B exists alone. The character “/” generally indicates that the associated objects before and after are in an “or” relationship. The singular forms “a,” “said” and “the” are also intended to include plurality, unless clearly indicated otherwise in the context.

The terms “first,” “second,” etc. are used to describe various information, but such information should not be limited to these terms. These terms are only used to distinguish information of the same category with each other, without indicating a specific order or an important degree. In fact, the expressions such as “first” and “second” may be used interchangeably. For example, without departing from the scope of the present disclosure, first information may be referred as second information; and similarly, second information may also be referred as first information.

Although the being described in a specific order in the drawings, the operations in the examples of the present disclosure should not be understood as requiring these operations to be performed in the specific order shown or in a serial order, or requiring the operations to be completely performed as illustrated to get a desired result. In certain circumstances, multitasking and parallel processing may be advantageous.

The present disclosure is intended to cover any variations, uses, or adaptations of the present disclosure that are in accordance with the general principles thereof and include common general knowledge or conventional technical means in the art that are not disclosed in the present disclosure. The specification and examples therein are only illustrative, and the scope and spirit of the present disclosure are to be indicated by appended claims.

The present disclosure is not limited to the above-described accurate structures illustrated in the drawings, and various modifications and changes can be made to the present disclosure without departing from the scope thereof. The scope of the present disclosure is to be limited only by the appended claims.

1. A cell handover method, comprising:
identifying, by a terminal, indication signaling, wherein the indication signaling is configured to indicate at least one candidate target cell and a rule for the terminal performing a cell handover; and
determining, by the terminal, based on the rule, a target cell of the cell handover from the at least one candidate target cell.

2. The cell handover method according to claim 1, wherein the indication signaling comprises conditional reconfiguration signaling and conditional re-adding module list signaling,
the conditional reconfiguration signaling is configured to indicate the at least one candidate target cell, and
the conditional re-adding module list signaling is configured to indicate the rule for the terminal performing the cell handover.

3. The cell handover method according to claim 1, wherein the rule comprises at least one of:
a handover priority based rule, or a signal quality strength based rule.

4. The cell handover method according to claim 3, wherein determining, based on the rule, the target cell of the cell handover from the at least one candidate target cell comprises:
determining, based on a handover priority of each of the at least one candidate target cell, at least one preferential target cell with a highest handover priority from the at least one candidate target cell;
determining one preferential target cell with the highest handover priority as the target cell, wherein the at least one preferential target cell with the highest handover priority comprises the one preferential target cell; and
determining a preferential target cell with a highest signal quality strength as the target cell of the cell handover, based on a signal quality strength of each of a plurality of preferential target cells, wherein the at least one preferential target cell with the highest handover priority comprises the plurality of preferential target cells.

5. The cell handover method according to 1, wherein the rule comprises a signal quality strength based rule; and
wherein determining, based on the rule, the target cell of the cell handover from the at least one candidate target cell comprises:
determining a signal quality strength of each of the at least one candidate target cell, and determining a candidate target cell of the at least one candidate target cell with a highest signal quality strength as the target cell.

6. A cell handover method, comprising:
determining, by a network device, at least one candidate target cell and a rule, wherein the rule is used for a terminal to determine a target cell of a cell handover from the at least one candidate target cell; and
transmitting, by the network device, indication signaling, wherein the indication signaling is configured to indicate the at least one candidate target cell and the rule for the terminal performing the cell handover.

7. The cell handover method according to claim 6, wherein the rule comprises at least one of:
a handover priority based rule, or a signal quality strength based rule.

8. The cell handover method according to claim 6, wherein the indication signaling comprises conditional reconfiguration signaling and conditional re-adding module list signaling,
the conditional reconfiguration signaling is configured to indicate the at least one candidate target cell, and
the conditional re-adding module list signaling is configured to indicate the rule for the terminal performing the cell handover.

9-10. (canceled)

11. A terminal, comprising:
one or more processors; and
one or more memories for storing instructions executable by the one or more processors;
wherein the one or more processors are configured to:
identify indication signaling, wherein the indication signaling is configured to indicate at least one candidate target cell and a rule for the terminal performing a cell handover; and
determine, based on the rule, a target cell of the cell handover from the at least one candidate target cell.

12. A non-transitory computer-readable storage medium, wherein instructions in the storage medium, when executed by one or more processors of a terminal, enable the terminal to perform the cell handover method according to claim 1.

13. A non-transitory computer-readable storage medium, wherein instructions in the storage medium, when executed by one or more processors of a terminal, enable the terminal to perform the cell handover method according to claim 6.

14. The cell handover method according to claim 1, further comprising:
performing, by the terminal, a cell handover procedure according to a conditional handover (CHO) command; and
identifying the indication signaling comprises:
identifying the indication signaling in the cell handover procedure.

15. The cell handover method according to claim 6, wherein a cell handover procedure is performed by the terminal according to a conditional handover (CHO) command and the at least one candidate target cell and the rule are determined in the cell handover procedure.

16. The terminal according to claim 11, wherein the one or more processors are further configured to:
perform a cell handover procedure according to a conditional handover (CHO) command; and
identify the indication signaling in the cell handover procedure.

17. The terminal according to claim 11, wherein the indication signaling comprises conditional reconfiguration signaling and conditional re-adding module list signaling,
the conditional reconfiguration signaling is configured to indicate the at least one candidate target cell, and
the conditional re-adding module list signaling is configured to indicate the rule for the terminal performing the cell handover.

18. The terminal according to claim 11, wherein the rule comprises at least one of:
a handover priority based rule, or a signal quality strength based rule.

19. The terminal according to claim 18, wherein the one or more processors are further configured to:
determine, based on a handover priority of each of the at least one candidate target cell, at least one preferential target cell with a highest handover priority from the at least one candidate target cell;
determine one preferential target cell with the highest handover priority as the target cell, wherein the at least one preferential target cell with the highest handover priority comprises the one preferential target cell; and
determine a preferential target cell with a highest signal quality strength as the target cell of the cell handover, based on a signal quality strength of each of a plurality of preferential target cells, wherein the at least one preferential target cell with the highest handover priority comprises the plurality of preferential target cells.

20. The terminal according to claim 11, wherein the rule comprises a signal quality strength based rule; and the one or more processors are further configured to:
determine a signal quality strength of each of the at least one candidate target cell, and determine a candidate target cell of the at least one candidate target cell with a highest signal quality strength as the target cell.

21. A network device, comprising:
one or more processors; and
one or more memories for storing instructions executable by the one or more processors;
wherein the one or more processors are configured to perform the cell handover method according to claim 6.

22. The network device according to claim 21, wherein a cell handover procedure is performed by the terminal according to a conditional handover (CHO) command and the at least one candidate target cell and the rule are determined in the cell handover procedure.
